(19) United States
(12) Patent Application Publication
(10) Pub. No.: US 2006/0203282 A1
(43) Pub. Date: Sep. 14, 2006

(54) Network printing system

(75) Inventor: Toshimichi Iwai, Tokyo (JP)

Correspondence Address: MORRISON & FOERSTER LLP, 1650 TYSONS BOULEVARD, SUITE 300, MCLEAN, VA, 22102, US

(73) Assignee: Konica Minolta Business Technologies, Inc., Tokyo (JP)

(21) Appl. No.: 11/179,672

(22) Filed: Jul. 13, 2005

(30) Foreign Application Priority Data
Mar. 8, 2005 (JP) 2005-063510

(51) Int. Cl. G06F 3/12

(52) U.S. Cl. 358/1.15

(57) ABSTRACT

In network printing for instructing printing with a computer, an image forming apparatus is selected in a plurality of image forming apparatuses connected through a network to the computer. Then, it is decided whether the selected image forming apparatus is present in a specific network area, and when the selected image forming apparatus is decided not to be present in the specific network area, a notice is served that the selected image forming apparatus is not present in the specific network area.

This application is based on application No. 2005-63510 filed in Japan, the contents of which are hereby incorporated by reference.

### BACKGROUND OF THE INVENTION

The invention relates to a network printing system including network printers.

Network environment is used widely, and information is shared in the network environment. The network is, for example, a local area network, a wide area network connecting local area networks, or the Internet. For example, in a local area network, personal computers (terminals) are connected to peripheral devices such as image forming apparatuses including printers and multi-functional peripherals, and files, printers and the like can be shared by the terminals. In a network printing system including network printers, a user of a terminal connected to the network can instruct printing to one of shared printers in the network.

As to a network printing system, various proposals for processing a print instruction are suggested. As the scale of network becomes larger, security becomes more important. For example, as described in Japanese Patent laid open Publication 2000-14614, a network printer checks a print request from a terminal in the network in order to improve the security, and the print data is outputted only when the printing is allowed, by excluding an unauthorized print request or printing at an erroneous network printer. For example, a filter or the like is used for transmitting only packets from a predetermined segment address. Further, a terminal table is provided to hold internet protocol (IP) addresses of terminals which can instruct printing to the network printer. When a print request is accepted, the terminal table is searched, and when a relevant entry is not found, the print request is not accepted. When print requests are accepted unrestrained as in a case of direct mail transmission, it is a problem that many unnecessary prints are produced. In order to prevent such unnecessary prints, in a network printer described in Japanese Patent laid open Publication 2003-122527, print requests decided necessary by the user are accepted selectively among the print requests from the terminals, while the other print requests are rejected. A table is provided for storing identification information on information sources whose print data should be rejected, and, by referring to the table, a print request from an information source registered in the table is rejected.

Further, when print jobs are executed in the order of print requests from clients, a print job of a remote client is liable to decrease the working efficiency of users as a whole. For example, prints produced in a print job of a remote client may be left for some time after the printing. Then, in a network printer described in Japanese Patent laid open Publication 2000-20266, the distance to a client who sends the print request is measured, and a print request from a client near the printer is incorporated preferentially in the queue of print jobs. Thus, the working efficiency of users as a whole is improved.

When a terminal instructs printing to a printer in a network printing system, if a printer used usually is selected as a default printer, the user is likely to instruct printing without confirming which printer is selected. However, if the user of the terminal in a network in an office performs printing in a different network in a different office or the like, he or she may instruct printing to the default printer unconsciously though he or she intends to print data at a near printer in the different network. If printing is instructed erroneously, unnecessary prints are produced, and paper sheets are consumed wastefully. Further, when the print data is secret information, a problem on the security occurs. In order to solve these problems, the above-mentioned proposals for a printer to decide the necessity of printing may be adopted. However, this needs to register and manage IP addresses of the terminals which uses the printer or information sources to reject transmission of data therefrom. Therefore, it is not practical.

### SUMMARY OF THE INVENTION

An object of the invention is to prevent erroneous printing at a remote image forming apparatus in a network printing system.

In a network printing method according to the invention for instructing printing with a computer, an image forming apparatus is selected in a plurality of image forming apparatuses connected through a network to the computer. Then, it is decided whether the selected image forming apparatus is present in a specific network area, and when the selected image forming apparatus is decided not to be present in the specific network area, a notice is served at the computer that the selected image forming apparatus is not present in the specific network area.

An advantage of the present invention is that erroneous printing can be prevented by serving a notice when a user selects a remote image forming apparatus erroneously for printing.

### BRIEF DESCRIPTION OF THE DRAWINGS

These and other objects and features of the present invention will become clear from the following description taken in conjunction with the preferred embodiments thereof with reference to the accompanying drawings, and in which:

FIG. 1 is a diagram of a network structure;

FIG. 2 is a block diagram of a personal computer;

FIG. 3 is a diagram for explaining the distance of network printing;

FIG. 4 is a diagram of a screen for instructing print;

FIG. 5 is a diagram of a screen for giving a warning; and

FIG. 6 is a flowchart of network printing.

### DETAILED DESCRIPTION OF THE PREFERRED EMBODIMENTS

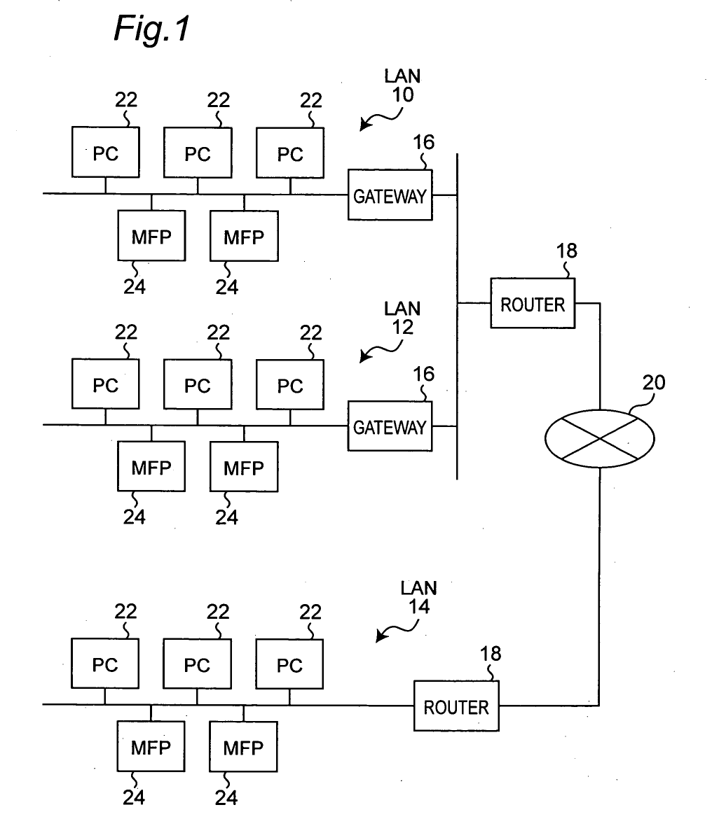

Referring now to the drawings, FIG. 1 schematically shows an example of a network printing system wherein printing is instructed to a printer through the network at a terminal such as a personal computer (PC). In FIG. 1, local area networks 10, 12 and 14 include terminals such as personal computers and image forming apparatuses 22 such as printers and multi-functional peripherals. (Hereinafter, an image forming apparatus is called generally as printer.) Such a network would include various types of servers or other peripherals though not shown in FIG. 1. The local area networks 10 and 12 are connected through a gateway 16 to each other to construct a larger local area network. Further, the local area networks 10, 12 and 14 are connected to each other through a router 18 and the Internet 20 (or a dedicated line). The local area network 14 is a remote local area network for the local area networks 10 and 12.

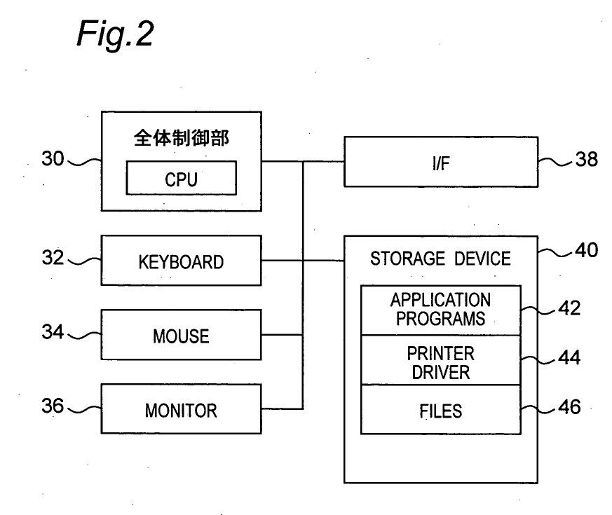

FIG. 2 shows a structure of the personal computer 22 as an example of a terminal connected to a network, wherein a controller 30 including a central processing unit (CPU) controls various components in the personal computer 2 and executes various programs. The controller 30 is connected to a keyboard 32, a mouse 34, a display monitor 36, a network interface (I/F) 38 for sending print data through the network, and a memory device 40 such as a hard disk drive for storing programs and data in a hard disk (not shown) therein. A user uses an application program 42 such as a word processor program or a spreadsheet program and instructs printing of data as the result of the execution of the application program 42 if necessary. A printer driver 44 receives a file 46 of print data from the application program 42 and converts the format of the data so as to be interpreted by the shared printer.

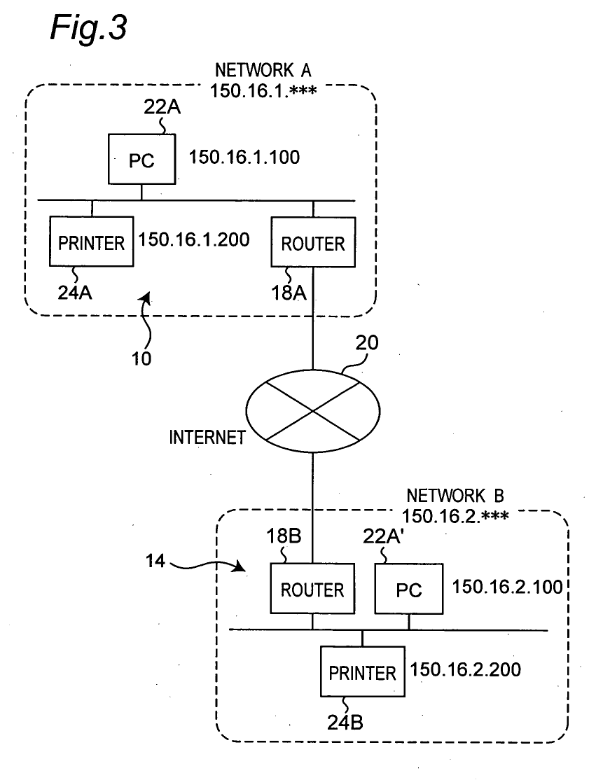

The concept of distance in network printing is explained. Hereinafter, “network” is referred to a specific network area having the same network address. FIG. 3 shows a part of the system shown in FIG. 1. In the network shown in FIG. 3, the personal computer 22A is a notebook computer, and it is portable and usually connected to the local area network 10 or a network “A” (having network address of 150.16.1), but it can be connected to the local area network 14 or a network “B” (having network address of 150.16.2). It is assumed here that internet protocol address (or IP address) of 150.16.1.100 is assigned to the notebook computer when it is connected to the network “A”, while that of 150.16.2.100 is assigned when it is connected to the network “B”. (In FIG. 3, the personal computer is denoted with reference numeral of 22A in the former case and with reference numeral of 22A′ in the latter case.) A printer 24A having IP address of 150.16.1.200 is connected to the network “A”, while another printer 24B having IP address of 150.16.2.200 is connected to the network “B”. The network “A” is connected through the router 18A to the Internet 20, and it can communicate through the router 18B with the network “B”. The personal computer 22A (20A′) can select the printer 24A or 24B with Internet Printing Protocol (IPP).

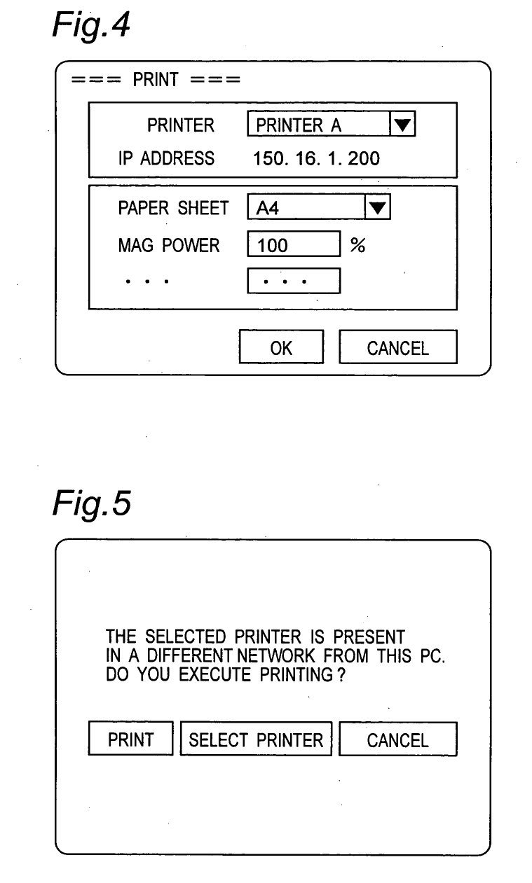

As mentioned above, the personal computer 22A is usually connected to the network “A” and selects the printer 24A as a default printer to be used usually. When printing is instructed, the printer to be selected is designated in a print screen as shown, for example, in FIG. 4. Further, print conditions such as paper sheet and magnifying power like can also be set on the screen. The user instructs printing by pressing “OK” button on the screen. When the personal computer 22A′ is connected in the network “B” in a different office, if the user of the personal computer 22A′ wants to instruct printing to the printer 24B in the network “B”, he or she has to operate to select the printer 24B as the printer to be used for printing. However, he or she may forget it is necessary to change the printer or may instruct printing erroneously to the remote printer 24A used as the default printer. In this embodiment, as explained below, it is checked, before instructing the printing to the selected printer, whether the selected printer is present in a specific network area. Then, if it is decided that the selected printer is not present in the specific network area which includes the personal computer 22A or, from a different viewpoint, which has a long distance between the printer 24A and the personal computer 22A, a notice is served on the possibility of erroneous printing.

Practically, a subnet mask is used to compare the IP addresses of the personal computer and the printer on a predetermined number of bits from the top of the IP address. For example, top three octets called network address are compared. If their network addresses are the same each other, the distance between them is determined to be short because they are present in the same network, otherwise the distance between them is determined to be long because they are not present in the same network. When the distance between them is determined to be long, it is warned in a screen of the personal computer. For example, as shown in FIG. 5, a warning message is displayed that the selected printer is present in a different network. Further, three buttons of “Print”, “Select printer” and “Cancel” are displayed on the screen so that the user can select one of them for execution of printing, selection of a different printer or cancellation of printing. When “Select printer” is instructed, the screen shown in FIG. 4 is displayed again.

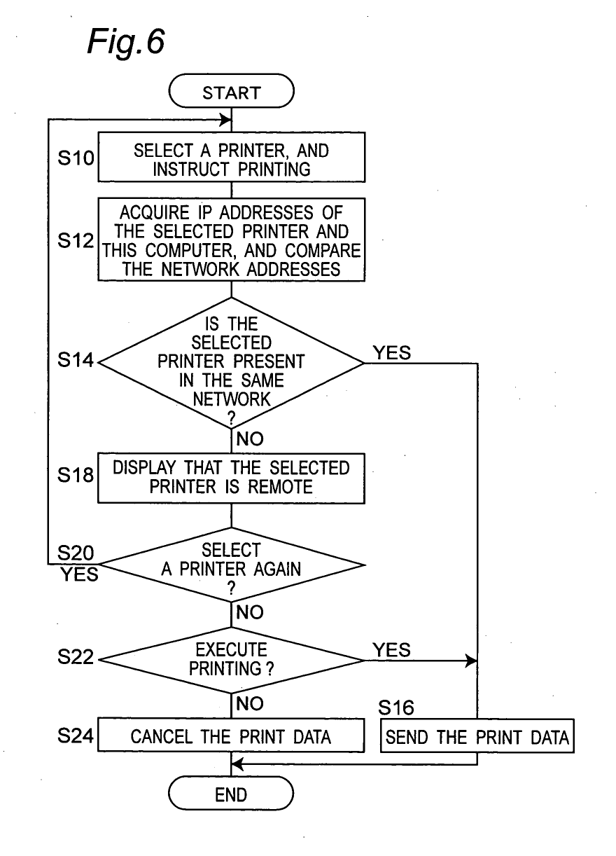

FIG. 6 shows a flowchart of a program for network printing according to the invention. The program is included in the printer driver. Alternatively, it is a part of the application program 42 executed by the controller 30. When printing of a result of execution of an application program 42 is instructed by a user, a print screen as shown in FIG. 4 is shown in the display monitor 36, at step S10. On the screen, the user can select the printer 24B in the network “B” besides the printer 24A in the network “A” as a printer to be used for the print instruction. After the printer is designated, execution of printing is instructed. In this case, if the user intends to instruct printing to the printer 24B located near the personal computer 22A′ in the network “B”, he or she has to change the printer to be used from the printer 24A set as the default printer to the printer 24B. It is assumed here that he or she forgets the operation or erroneously selects the printer 24A, and presses “OK” button on the screen shown in FIG. 4. Next at step S12, the IP address of the selected printer 24A and that of the personal computer 22A′ are obtained, and a predetermined number of upper bits from the top of the two IP addresses are compared with each other. The top three octets called as network address are compared here. At step S14, it is decided whether the network address of the personal computer 22A′ agrees with that of the printer selected at step S12. If they agree with each other or they are present in the same network, the flow proceeds to step S16 for transmission of the print data, while if they do not agree with each other, the flow proceeds to step S18. In this case, the network address of the erroneously selected printer 24A is 150.16.1, while that of the personal computer 22A′ is 150.16.2. Therefore, the two network addresses are different from each other, and the flow proceeds to step S18. At step S18, a warning message that the selected printer is present in a different network is shown on the display monitor 36, as shown in FIG. 5, and it is requested for the user to select one of execution of printing, selection of printer and cancellation of printing. At step S20, when it is decided that selection of printer is instructed by the user, the flow returns to step S10 to select a printer. When it is not decided at step S20 that selection of printer is instructed and when it is decided at step S22 that execution of printing is instructed by the user, the flow proceeds to step S16 to transmit the print data. When it is decided that neither of execution of printing and selection of printer is instructed, or when it is decided that cancellation of printing is instructed by the user (NO at step S22), the print data is canceled, and the processing is completed. On the other hand, when it is decided at step S10 that the printer 24B is selected correctly as the printer to be used, the network address of the printer 24B is 150.16.2 or it agrees with that of the personal computer 22A′. Then, the flow proceeds to step S16.

As explained above, in the network printing system according to the embodiment, even when a user wants to instruct printing to a printer in the same network but erroneously instructs printing to a remote printer in a different network, an appropriate notice or warning is given to the user. Therefore, erroneous printing is prevented, and unnecessary prints are not produced. Further, secret information can be prevented to be printed at a remote printer where the erroneous prints cannot be collected instantly, so that the safety on security is improved.

In the above-mentioned embodiment, it is decided based on the comparison of the network address in IP v4 as a logical address in the network whether the selected printer is present in the specific network area. However, the comparison may be based on the network prefix in IP v6.

Further, when a predetermined part of the bits in a host address other than the network address in an IP address are assigned by taking the distance into account, that is, when the part of the bits are assigned commonly to terminals and peripheral devices having smaller distances between them, a specific network area can be set within the local area network 10, 12 or 14. In such a case, by using a subnet mask including the part of the bits, it can be decided based on the IP address whether the distance between the personal computer and the printer is short or not. This distance can also be applied to a private address. Thus, even in the same local area network, it can be decided whether the distance between a personal computer and a printer is short or long.

Alternatively, it can be decided based on the distance between the selected printer and the personal computer whether the selected printer is present in the specified network area. For example, the distance may be detected according to a response time for a PING command used for confirming the possibility of communication, as in a printer described in Japanese Patent laid open Publication 2000-20266. In the printer, the distance to a personal computer is measured, and the order of execution of print jobs is changed according to the distance. On the other hand, in this embodiment, the PING command is used to measure the distance to the printer. When the measured response time is longer than a threshold time, it is decided that the printer is not present in the specific network area, and a warning message as shown in FIG. 5 is displayed. Alternatively, the number of relays such as routers in a transmission path from the personal computer to the printer can be acquired by using the above-mentioned PING command, and it is determined that the printer is present in a specific network area including the personal computer when the acquired number of relays is larger than a threshold.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A network printing method for instructing printing with a computer, the method comprising the steps of:
selecting an image forming apparatus in a plurality of image forming apparatuses connected through a network to the computer;
deciding whether the selected image forming apparatus is present in a specific network area; and
serving a notice at the computer that the selected image forming apparatus is not present in the specific network area when the selected image forming apparatus is decided not to be present in the specific network area.

2. The method according to claim 1, further comprising the step of instructing printing to the selected image forming apparatus after it is decided that the selected image forming apparatus is present in the specific network area.

3. The method according to claim 2, wherein the selection of an image forming apparatus and the instruction of printing are performed in the same screen.

4. The method according to claim 1, wherein the specific network area includes the computer in the network.

5. The method according to claim 1, wherein the decision whether the selected image forming apparatus is present in the specific network area is based on comparison between an address of the computer and that of the selected image forming apparatus.

6. The method according to claim 5, wherein the address is internet protocol address, and it is decided that the selected image forming apparatus is present in the specific network area when predetermined bits in the internet protocol address of the selected image forming apparatus are the same as those of the computer.

7. The method according to claim 1, wherein the decision whether the selected image forming apparatus is present in the specific network area is based on comparison of a distance between the computer and the selected image forming apparatus with a threshold.

8. The method according to claim 7, further comprising the step of measuring the distance between the computer and the selected image forming apparatus.

9. The method according to claim 1, wherein in the serving step, a screen for displaying the notice is displayed.

10. The method according to claim 9, wherein execution of the printing and change in the selected image forming apparatus can be instructed on the screen of the computer.

11. A network printing program to be executed by a computer for instructing printing with a computer, the program comprising the steps of:
selecting an image forming apparatus in a plurality of image forming apparatuses connected through a network to the computer;
deciding whether the selected image forming apparatus is present in a specific network area; and
serving a notice at the computer that the selected image forming apparatus is not present in the specific network area when the selected image forming apparatus is decided not to be present in the specific network area.

12. The program according to claim 11, further comprising the step of instructing printing to the selected image forming apparatus after it is decided that the selected image forming apparatus is present in the specific network area.

13. The method according to claim 12, wherein the selection of an image forming apparatus and the instruction of printing are received in the same screen.

14. The method according to claim 11, wherein the specific network area includes the computer in the network.

15. The method according to claim 11, wherein the decision whether the selected image forming apparatus is present in the specific network area is based on comparison between an address of the computer and that of the selected image forming apparatus.

16. The method according to claim 15, wherein the address is internet protocol address, and it is decided that the selected image forming apparatus is present in the specific network area when predetermined bits in the internet protocol address of the selected image forming apparatus are the same as those of the computer.

17. The program according to claim 11, wherein the decision whether the selected image forming apparatus is present in the specific network area is based on comparison of a distance between the computer and the selected image forming apparatus with a threshold.

18. The program according to claim 17, further comprising the step of measuring the distance between the computer and the selected image forming apparatus.

19. The method according to claim 11, wherein in the serving step, a screen for displaying the notice is displayed.

20. The method according to claim 19, wherein execution of the printing and change in the selected image forming apparatus can be instructed on the screen of the computer.
